(19) United States
(12) Patent Application Publication
(10) Pub. No.: US 2023/0053830 A1
(43) Pub. Date: Feb. 23, 2023

(54) SYSTEM AND METHOD FOR ASSEMBLING VEHICLE COMPONENT

(71) Applicants: HYUNDAI MOTOR COMPANY, Seoul (KR); KIA CORPORATION, Seoul (KR)

(72) Inventor: Ji Eun Jang, Gwangyang-si (KR)

(21) Appl. No.: 17/865,896

(22) Filed: Jul. 15, 2022

(30) Foreign Application Priority Data
Aug. 17, 2021 (KR) 10-2021-0108251

(51) Int. Cl. B25J 9/16; G06T 1/00; G06T 7/00

(52) U.S. Cl. CPC B25J 9/1697; G06T 1/0014; G06T 7/001; G06T 2207/30164

(57) ABSTRACT

Disclosed are a method and system for assembling a vehicle component, the system including an image capturing unit configured to capture an image of a mounted vehicle component and an image of an assembly point on a vehicle to which the vehicle component is assembled, an assembly robot configured to load the mounted vehicle component, move the loaded vehicle component to the assembly point on the vehicle, and assemble the vehicle component to the assembly point, and a control unit configured to analyze the image of the vehicle component captured by the image capturing unit, control the assembly robot to allow the assembly robot to load the mounted vehicle component at the same point, analyze the image of the assembly point on the vehicle, and control the assembly robot to allow the assembly robot to assemble the vehicle component accurately to the assembly point of the vehicle.

### CROSS REFERENCE TO RELATED APPLICATION

The present application claims priority to Korean Patent Application No. 10-2021-0108251, filed Aug. 17, 2021, the entire contents of which is incorporated herein for all purposes by this reference.

### BACKGROUND

### Field

The present disclosure relates to a system and method for assembling a vehicle component, and more particularly, to a system and method for assembling a vehicle component which utilizes 3D scanning or the like to eliminate irregular assembly quality. Irregular assembly quality may be caused when operators individually and manually mount and assemble vehicle components, such as undercovers for a vehicle, with various materials and shapes for various types of vehicles. The disclosed system and method for eliminating irregular assembly quality corrects dispersion of various types of vehicles and vehicle components, relieving the burden on the operators caused by overhead work, and maintaining uniform mounting quality.

### Description of the Related Art

Hardware components including bolts, nuts, and clips are mechanical elements widely used to couple two or more components. In general, a process of fastening the hardware component is performed by matching the hardware component to two opposite positions of an undercover and rotating, by an operator, a nut or clip in a bolting direction with a fastening tool.

An apparatus for automatically fastening the hardware component to the undercover is essential to manufacture a finished product produced by assembling the hardware component and the undercover. However, the process of fastening the hardware component to the undercover is not easy because it is difficult to position a lower portion of the hardware component at an exact position. The reason is that the configurations and devices, which are configured for respective shapes and types of finished products, are dispersed during the operation of assembling various finished products through a single process, assembly positions of the hardware components for fastening the devices of the finished products are dispersed, and materials, shapes, and sizes of the undercovers are dispersed. Furthermore, in a situation in which the operator directly performs the fastening process, a defect may occur due to a mistake of the operator, and it is challenging to ensure productivity. Therefore, there is an acute need for automation of the assembly process.

The above-mentioned matters described as the background art are provided merely to aid understanding of the background of the present disclosure, and should not be construed to admit that the matters correspond to the technologies already known to those skilled in the art.

### SUMMARY

The present disclosure is proposed to solve these problems and aims to provide a system and method for assembling a vehicle component, which utilizes 3D scanning or the like to eliminate irregular assembly quality, which may be caused when operators individually and manually mount and assemble vehicle components, such as under covers for a vehicle, with various materials and shapes for various types of vehicles, thereby correcting dispersion of various types of vehicles and vehicle components, relieving the burden on the operators caused by overhead work, and maintaining uniform mounting quality.

The present disclosure provides a system for assembling a vehicle component, the system including an image capturing unit configured to capture an image of a mounted vehicle component and an image of an assembly point on a vehicle to which the vehicle component is assembled, an assembly robot configured to load the mounted vehicle component, move the loaded vehicle component to the assembly point on the vehicle, and assemble the vehicle component to the assembly point; and a control unit configured to analyze the image of the vehicle component captured by the image capturing unit, control the assembly robot to allow the assembly robot to load the mounted vehicle component at the same point, analyze the image of the assembly point on the vehicle, and control the assembly robot to allow the assembly robot to assemble the vehicle component accurately to the assembly point of the vehicle.

The control unit may analyze the image of the vehicle component and the image of the assembly point on the vehicle, which are captured by the image capturing unit, calculate loading information associated with a loading point of the vehicle component and assembly information associated with the assembly point of the vehicle component, calculate errors from preset reference loading information and reference assembly information depending on the calculated loading information associated with the loading point of the vehicle component and the calculated assembly information associated with the assembly point of the vehicle component, and control the assembly robot depending on the calculated errors.

The assembly robot may include includes a loading robot configured to load the mounted vehicle component and move the loaded vehicle component to the assembly point on the vehicle, and a fastening robot configured to assemble the moved vehicle component to the assembly point by positioning a hardware component, including one or more types of bolts, nuts, or clips, at the assembly point and applying torque to the hardware component.

The control unit may analyze the image of the vehicle component and the image of the assembly point on the vehicle, which are captured by the image capturing unit, calculate loading information associated with a loading point of the vehicle component and assembly information associated with the assembly point of the vehicle component, calculate errors from a reference loading point and a reference assembly point depending on the calculated loading point and the calculated assembly point of the vehicle component, derive movement routes of the loading robot and the fastening robot depending on the calculated errors, and control operations of the loading robot and the fastening robot depending on the derived movement routes.

The control unit may analyze the image of the assembly point on the vehicle, calculate fastening information associated with a fastening point of the hardware component, calculate an error from a preset reference fastening information depending on the calculated fastening information, and control an operation of the fastening robot depending on the calculated error in a case in which the hardware component is fastened and assembled to the assembly point in a state in which the vehicle component is loaded to the loading point.

The loading robot may further include a sucking unit configured to suck the mounted vehicle component, and a vacuum blower configured to generate sucking power in the sucking unit.

The loading robot may further include a servo motor configured to move the sucking unit, and a precise movement device configured to operate the servo motor by receiving sucking positions of the sucking unit which are different for respective types of vehicles.

The control unit may further include a fastening inspection unit configured to inspect whether the assembly robot accurately assembles the vehicle component to the assembly point on the vehicle by fastening one or more types of hardware components among bolts, nuts, or clips to the vehicle component, and the fastening inspection unit may control the image capturing unit to capture, at multiple angles, images of an assembled state of the vehicle in which the vehicle component is assembled, process the images captured at multiple angles by the image capturing unit, generate fastening inspection information associated with a result of inspecting the fastening of the hardware component, calculate an error between the fastening inspection information and preset reference fastening information, and control an operation of the assembly robot depending on the calculated error.

The present disclosure provides a method of assembling a vehicle component, the method including capturing, by an image capturing unit, an image of a mounted vehicle component and an image of an assembly point on a vehicle to which the vehicle component is assembled, loading, by an assembly robot, the mounted vehicle component, moving the loaded vehicle component to the assembly point on the vehicle, and assembling the vehicle component to the assembly point, and analyzing, by a control unit, the image of the vehicle component, controlling the assembly robot to load the mounted vehicle component at the same point, analyzing the image of the assembly point on the vehicle, and controlling the assembly robot to assemble the vehicle component accurately to the assembly point on the vehicle.

In the controlling step, the control unit may analyze the image of the vehicle component and the image of the assembly point on the vehicle, which are captured by the image capturing unit, calculate loading information associated with a loading point of the vehicle component and assembly information associated with the assembly point of the vehicle component, calculate errors from preset reference loading information and reference assembly information depending on the calculated loading information associated with the loading point of the vehicle component and the calculated assembly information associated with the assembly point of the vehicle component, and control the assembly robot depending on the calculated errors.

After the controlling step, a fastening inspection unit may control the image capturing unit to capture, at multiple angles, images of an assembled state of the vehicle in which the vehicle component is assembled, process the images captured at multiple angles by the image capturing unit, generates fastening inspection information associated with a result of inspecting the fastening of a hardware component, calculate an error between the fastening inspection information and preset reference fastening information, and control an operation of a fastening robot depending on the calculated error.

In the assembling step, a loading robot may load the mounted vehicle component and move the loaded vehicle component to the assembly point on the vehicle, and a fastening robot may assemble the moved vehicle component to the assembly point by positioning a hardware component, including one or more types of bolts, nuts, or clips, to the assembly point and applying torque to the hardware component.

In the controlling step, the control unit may analyze the image of the assembly point on the vehicle, calculate fastening information associated with a fastening point of the hardware component, calculate an error from a preset reference fastening information depending on the calculated fastening information, and control an operation of the fastening robot depending on the calculated error in a case in which the hardware component is fastened and assembled to the assembly point in a state in which the vehicle component is loaded to a loading point.

In the controlling step, the control unit may analyze the image of the vehicle component and the image of the assembly point on the vehicle, which are captured by the image capturing unit, calculate loading information associated with a loading point of the vehicle component and assembly information associated with the assembly point of the vehicle component, calculate errors from a reference loading point and a reference assembly point depending on the calculated loading point and the calculated assembly point of the vehicle component, derive movement routes of a loading robot and a fastening robot depending on the calculated errors, and control operations of the loading robot and the fastening robot depending on the derived movement routes.

In the assembling step, the loading robot may receive sucking positions of a sucking unit, which are different for respective types of vehicles, and operate a servo motor to a sucking position, and a vacuum blower may generate sucking power in the sucking unit positioned at the sucking position.

According to the system and method for assembling a vehicle component according to the present disclosure, it is possible to utilize 3D scanning or the like to eliminate irregular assembly quality, which may be caused when operators individually and manually mount and assemble vehicle components, such as under covers for a vehicle, with various materials and shapes for various types of vehicles, thereby correcting dispersion of various types of vehicles and vehicle components, relieving the burden on the operators caused by overhead work, and maintaining uniform mounting quality.

### BRIEF DESCRIPTION OF THE DRAWINGS

FIG. 1 is a block diagram of a vehicle component assembly system according to an embodiment of the present disclosure.

FIG. 2 is a view illustrating a mechanism that implements the vehicle component assembly system according to the embodiment of the present disclosure.

FIG. 3 is a view illustrating a loading mechanism of the vehicle component assembly system according to the embodiment of the present disclosure.

FIG. 4 is a view illustrating a loading unit of the vehicle component assembly system according to the embodiment of the present disclosure.

FIG. 5 is a view illustrating a mechanism fastened by the vehicle component assembly system according to the embodiment of the present disclosure.

FIG. 6 is a view illustrating a loading point of the vehicle component assembly system according to the embodiment of the present disclosure.

FIG. 7 is a view illustrating a vehicle component assembly point of the vehicle component assembly system according to the embodiment of the present disclosure.

FIG. 8 is a view illustrating a hardware component fastening point of the vehicle component assembly system according to the embodiment of the present disclosure.

FIG. 9 is a view illustrating a captured image of the assembly point of the vehicle component assembly system according to the embodiment of the present disclosure.

FIG. 10 is a flowchart illustrating a vehicle component assembly method according to the embodiment of the present disclosure.

### DETAILED DESCRIPTION

Specific structural or functional descriptions of exemplary embodiments of the present disclosure disclosed in this specification or application are exemplified only for the purpose of explaining the exemplary embodiments according to the present disclosure, the exemplary embodiments according to the present disclosure may be carried out in various forms, and it should not be interpreted that the present disclosure is limited to the exemplary embodiments described in this specification or application. Hereinafter, an embodiment of the present disclosure will be described in detail with reference to the accompanying drawings.

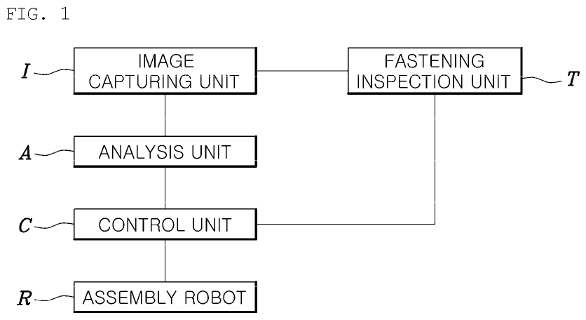

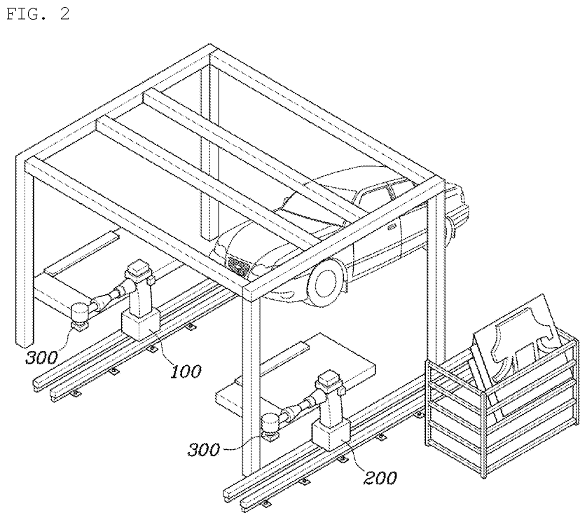

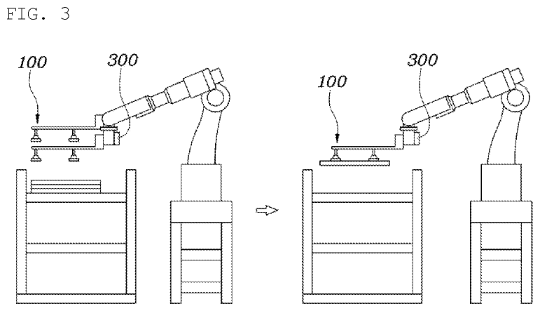

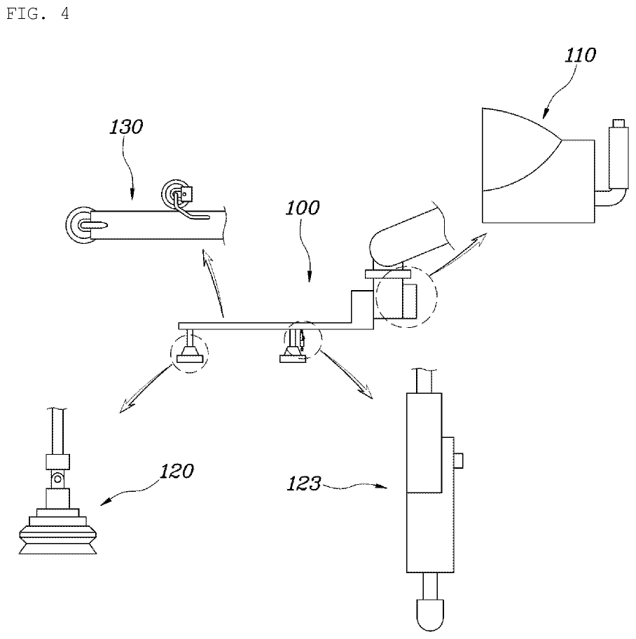

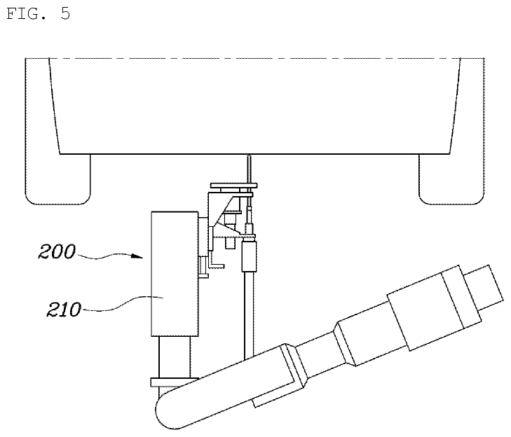

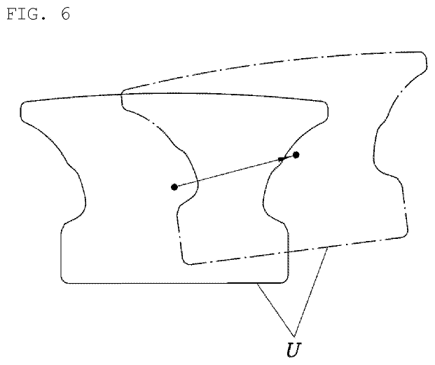

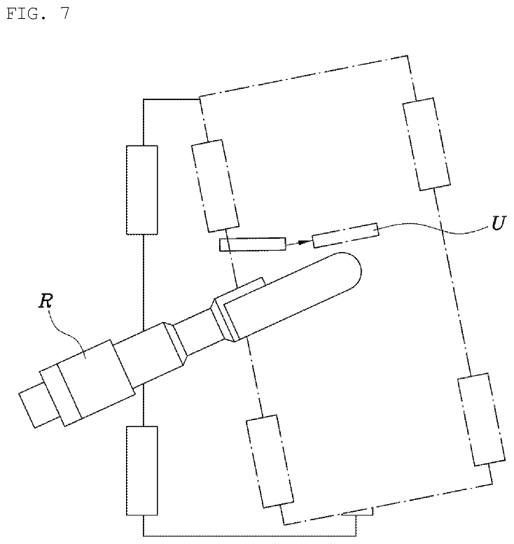

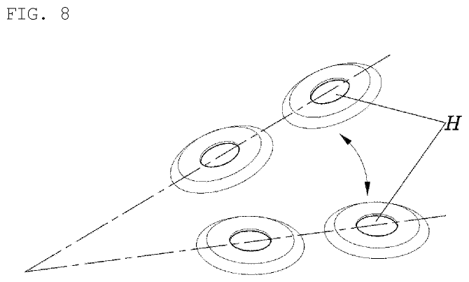

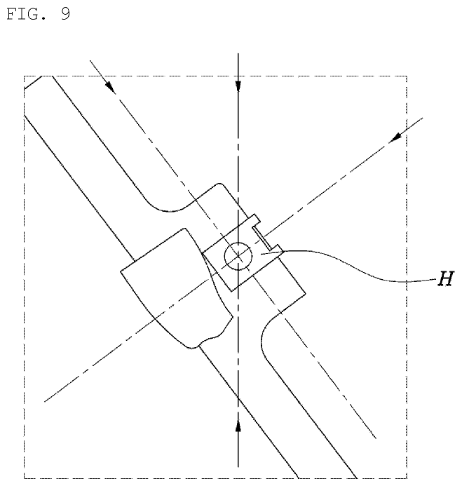

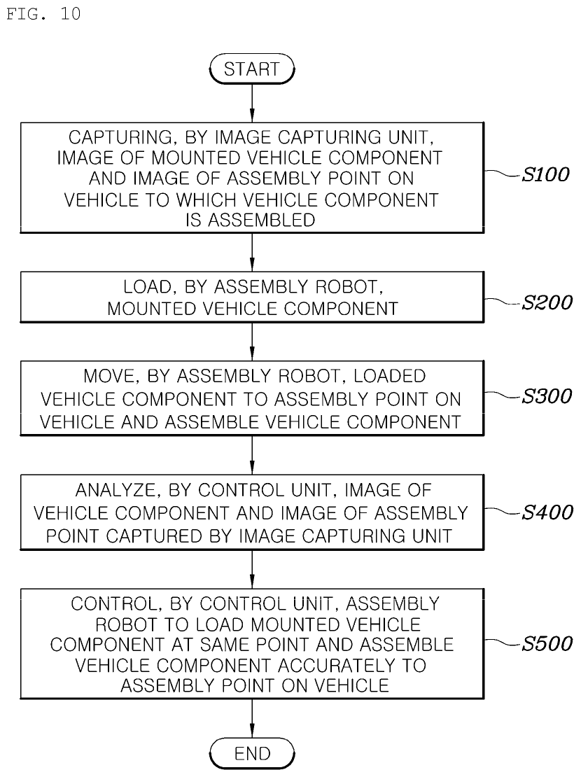

FIG. 1 is a block diagram of a vehicle component assembly system according to an embodiment of the present disclosure, FIG. 2 is a view illustrating a mechanism that implements the vehicle component assembly system according to the embodiment of the present disclosure, FIG. 3 is a view illustrating a loading mechanism of the vehicle component assembly system according to the embodiment of the present disclosure, FIG. 4 is a view illustrating a loading unit of the vehicle component assembly system according to the embodiment of the present disclosure, FIG. 5 is a view illustrating a mechanism fastened by the vehicle component assembly system according to the embodiment of the present disclosure, FIG. 6 is a view illustrating a loading point of the vehicle component assembly system according to the embodiment of the present disclosure, FIG. 7 is a view illustrating a vehicle component assembly point of the vehicle component assembly system according to the embodiment of the present disclosure, FIG. 8 is a view illustrating a hardware component fastening point of the vehicle component assembly system according to the embodiment of the present disclosure, FIG. 9 is a view illustrating a captured image of the assembly point of the vehicle component assembly system according to the embodiment of the present disclosure, and FIG. 10 is a flowchart illustrating a vehicle component assembly method according to the embodiment of the present disclosure.

FIG. 1 is a block diagram of the vehicle component assembly system according to an embodiment of the present disclosure. The vehicle component assembly system according to an embodiment of the present disclosure includes an image capturing unit I configured to capture images of a mounted vehicle component and an assembly point on a vehicle to which the vehicle component is assembled, an assembly robot R configured to load the mounted vehicle component, move the loaded vehicle component to the assembly point on the vehicle, and assemble the vehicle component to the assembly point, and a control unit C configured to analyze the image of the vehicle component captured by the image capturing unit and control the assembly robot to allow the assembly robot to load the vehicle component at the same point of the mounted vehicle component, the control unit C being configured to analyze the image of the vehicle component of the vehicle and control the assembly robot to allow the assembly robot to assemble the vehicle component accurately to the assembly point on the vehicle.

As illustrated in FIG. 1, the image capturing unit I captures the images of the mounted vehicle component and the assembly point on the vehicle to which the vehicle component is assembled. In this case, the vehicle component may be mounted in a physical distribution space disposed in an assembly cell (a space in which the process of assembling the vehicle is performed) or moved and mounted by a movement robot (automated guided vehicle (AGV)) that moves the vehicle component through a physical distribution movement route provided in the order of the processes of the vehicle. Further, the image capturing unit captures images associated with the mounted state of the vehicle component, images associated with the mounted vehicle component before and after the vehicle component is loaded onto the assembly robot, images associated with the assembly point on the vehicle to which the vehicle component is assembled, and images associated with the assembly point on the vehicle before and after the vehicle component loaded at the loading point is assembled by being fastened to the hardware component including at least one of bolts, nuts, and clips.

As illustrated in FIG. 1, the assembly robot R loads the mounted vehicle component, moves the loaded vehicle component to the assembly point on the vehicle, and assembles the vehicle component to the assembly point. To automate the assembly process, all the loading/moving/assembling/fastening processes may be performed by the assembly robot, a drive unit (not illustrated) for operating the assembly robot, and the control unit C for controlling the assembly robot.

As illustrated in FIG. 1, the control unit C may include an analysis unit A configured to analyze the image of the vehicle component captured by the image capturing unit. The analysis unit A may extract and analyze the type of vehicle and the type of vehicle component from a database associated with the vehicle and the vehicle component in a state in which the type of vehicle and the type of vehicle component are specified. Alternatively, the information may include the type of vehicle and the type of vehicle component extracted by learning the images of the vehicle or the vehicle component captured at multiple angles based on the algorithm such as the deep-learning technique, the learning-based image processing technique, or the non-learning-based image processing technique, movement vectors including a movement route and a movement amount of the assembly robot or a position on the vehicle to which the vehicle component is assembled, and feature points for specifying the loading point, the assembly point, the fastening point, and the fastening hardware component.

As illustrated in FIG. 1, depending on the information processed by the analysis unit, the control unit C controls the assembly robot to allow the assembly robot to load the mounted vehicle component at the same point and controls the assembly robot to accurately assemble the vehicle component at the assembly point on the vehicle. In this case, the control unit may calculate loading information associated with the loading point of the vehicle component and assembly information associated with the assembly point of the vehicle component by analyzing the image of the vehicle component and the image of the assembly point on the vehicle which are captured by the image capturing unit. The control unit may calculate errors from preset reference loading information and reference assembly information depending on the calculated loading information associated with the loading point of the vehicle component and the calculated assembly information associated with the assembly point of the vehicle component and control the assembly robot depending on the calculated errors. That is, the control unit may control the assembly robot by correcting the error.

FIG. 2 is a view illustrating a mechanism that implements the vehicle component assembly system according to the embodiment of the present disclosure. The assembly robot may include a loading robot configured to load the mounted vehicle component and move the loaded vehicle component to the assembly point on the vehicle, and a fastening robot configured to assemble the moved vehicle component to the assembly point by positioning the hardware component, including one or more types of bolts, nuts, or clips, at the assembly point and applying torque to the hardware component.

As illustrated in FIG. 2, the assembly robot for performing the process of assembling the vehicle component broadly includes a loading unit 100 configured to load the mounted vehicle component, an automatic fastening unit 200 configured to be automatically supplied with the hardware component and automatically fasten the hardware component, and a vision unit 300 configured to capture images associated with loaded/moved/assembled/fastened/inspected states so that the mounted vehicle component is assembled to a particular position on the vehicle by fastening the hardware component. The operation of the loading unit may be performed by the loading robot. The automatic fastening unit may include a supply unit configured to automatically supply the hardware component to the fastening unit, and a fastening unit configured to position the hardware component, supplied from the supply unit, on the torque applying unit so that the hardware component may be fastened to the fastening position.

FIG. 3 is a view illustrating a loading mechanism of the vehicle component assembly system according to the embodiment of the present disclosure. The vision unit 300 may include an image capturing unit, a fixing unit including a gripper such as a robot arm for fixing the image capturing unit, and an adjustment unit configured to adjust a focal point of the image capturing unit. The image capturing unit included in the vision unit 300 captures an image of a state before the mounted vehicle component is loaded into a storage. The control unit processes the captured image and controls the loading unit 100 to position the loading unit 100 at the same position. As illustrated in FIG. 3, the loading robot loads the mounted vehicle component by sucking the mounted vehicle component, and the sucking position may also be controlled so that the sucked vehicle component is loaded at the same position.

FIG. 4 is a view illustrating the loading unit of the vehicle component assembly system according to the embodiment of the present disclosure. The loading unit 100 includes the loading robot. The loading robot may further include a sucking unit 120 configured to suck the mounted vehicle component, and a vacuum blower 110 configured to generate sucking power in the sucking unit. Further, the loading robot may further include a servo motor configured to move the sucking unit, and a precise movement device 130 configured to operate the servo motor by receiving the sucking positions of the sucking unit which are different for respective types of vehicles. Further, the loading robot may further include a shape restriction device installed on the sucking unit and configured to support the sucked vehicle component so that the vehicle component does not separate from the sucking position of the sucking unit. The sucking unit 120 may include a sucking cup and a spring disposed on the sucking cup, and the sucking cup and the spring may constitute a swiveling rotational structure that copes with the waviness of the vehicle component.

FIG. 5 is a view illustrating a mechanism fastened by the vehicle component assembly system according to the embodiment of the present disclosure. The automatic fastening unit 200, which automatically receives the hardware component and automatically fasten the hardware component, may include a supply unit configured to automatically supply the hardware component to the fastening unit, and a fastening unit 210 configured to position the hardware component, supplied from the supply unit, on the torque applying unit so that the hardware component may be fastened to the fastening position.

As illustrated in FIG. 5, in the case in which the vehicle component is assembled to a lower portion of the vehicle by fastening the hardware component, a hanger unit configured to fix the vehicle at the top side may be provided in the assembly process. To automatically fasten and assemble the vehicle component to the lower portion of the vehicle fixed at the top side, the automatic fastening unit 200 may be automatically supplied with the hardware component from the supply unit. The automatic fastening unit 200 may allow the hardware component, supplied from the supply unit, to be fastened to the fastening position by the torque applying unit configured to apply torque.

FIG. 6 is a view illustrating the loading point of the vehicle component assembly system according to the embodiment of the present disclosure. The control unit may calculate loading information associated with the loading point of the vehicle component and assembly information associated with the assembly point of the vehicle component by analyzing the image of the vehicle component and the image of the assembly point on the vehicle which are captured by the image capturing unit. The control unit may calculate errors from the reference loading point and the reference assembly point depending on the calculated loading point and the calculated assembly point of the vehicle component. The control unit may derive movement routes of the loading robot and the fastening robot depending on the calculated errors and control the operations of the loading robot and the fastening robot depending on the derived movement routes.

As illustrated in FIG. 6, the image capturing unit captures the image of the vehicle component in a top plan view. The control unit extracts a feature point or the like from the captured and generated image of the vehicle component and calculates the loading information associated with the loading point. Further, the control unit compares the loading information with the reference loading point extracted from the image of the vehicle component, which is a pre-stored criterion, and controls the operation of the loading robot in a direction in which the loading point is corrected to the reference loading point depending on the comparison. In particular, the operation may be performed by controlling the movement route and the movement amount before the loading robot loads the vehicle component.

FIG. 7 is a view illustrating a vehicle component assembly point of the vehicle component assembly system according to the embodiment of the present disclosure. The control unit may calculate loading information associated with the loading point of the vehicle component and assembly information associated with the assembly point of the vehicle component by analyzing the image of the vehicle component and the image of the assembly point on the vehicle which are captured by the image capturing unit. The control unit may calculate errors from the reference loading point and the reference assembly point depending on the calculated loading point and the calculated assembly point of the vehicle component. The control unit may derive movement routes of the loading robot and the fastening robot depending on the calculated errors and control the operations of the loading robot and the fastening robot depending on the derived movement routes.

As illustrated in FIG. 7, the image capturing unit captures an image of a part of the vehicle component to be assembled to the lower portion of the vehicle in a bottom plan view. The control unit extracts the feature point or the like from the captured and generated image of the assembly point and calculates the assembly information associated with the assembly point. Further, the control unit compares the assembly information with the reference assembly point extracted from the image of the lower portion of the vehicle, which is a pre-stored criterion, and controls the operation of the assembly robot in a direction in which the assembly point is corrected to the reference assembly point depending on the comparison. In particular, the operation may be performed by controlling the movement route and the movement amount before the assembly robot assembles the vehicle component.

The control unit may analyze the image of the assembly point on the vehicle, calculate the fastening information associated with the fastening point of the hardware component, calculate an error from a preset reference fastening information depending on the calculated fastening information, and control the operation of the fastening robot depending on the calculated error in the case in which the hardware component is fastened and assembled to the assembly point in the state in which the vehicle component is loaded at the loading point.

FIG. 8 is a view illustrating a hardware component fastening point of the vehicle component assembly system according to the embodiment of the present disclosure. The control unit may analyze the image of the assembly point on the vehicle, calculate the assembly information associated with the assembly point of the vehicle component, calculate an error from the reference assembly point depending on the calculated assembly point of the vehicle component, derive the movement route of the fastening robot depending on the calculated error, and control the operation of the fastening robot depending on the derived movement route.

As illustrated in FIG. 8, the image capturing unit captures an image of a portion where a nut including a fastening hole among the hardware components is to be fastened in a bottom plan view of the vehicle. The control unit extracts the feature point or the like from the captured and generated image of the assembly point including the fastening hole and calculates the fastening information associated with the fastening point and the assembly point of the hardware component. Further, the control unit compares the fastening information with the reference fastening point extracted from the image of the lower portion of the vehicle, which is a pre-stored criterion, and controls the operation of the fastening robot in a direction in which the fastening point is corrected to the reference fastening point depending on the comparison. In particular, the operation may be performed by controlling the movement route and the movement amount before the fastening robot fastens the vehicle component with the hardware component.

FIG. 9 is a view illustrating a captured image of the assembly point of the vehicle component assembly system according to the embodiment of the present disclosure. The control unit may further include the fastening inspection unit configured to inspect whether the assembly robot accurately assembles the vehicle component to the assembly point on the vehicle by fastening one or more types of hardware components among the bolts, nuts, or the clips to the vehicle component. The fastening inspection unit may control the image capturing unit to allow the image capturing unit to capture the images, at multiple angles, the assembled state of the vehicle in which the vehicle component is assembled. The fastening inspection unit may process the images captured at multiple angles by the image capturing unit, generate fastening inspection information associated with the result of inspecting the fastening of the hardware component, calculate an error between the fastening inspection information and the preset reference fastening information, and control the operation of the assembly robot depending on the calculated error.

As illustrated in FIG. 9, the fastening inspection unit may control the image capturing unit to allow the image capturing unit to capture images, at four angles, the assembled state of the vehicle in which the vehicle component is assembled to a fastening hole H to which the hardware component is fastened. The fastening inspection unit generates a point cloud image by combining the images at multiple angles acquired by the image capturing unit. That is, the fastening inspection unit may extract a coordinate value, for each point, associated with a gradient of the bolt, as the hardware component, and a curved shape of a fastened edge. Therefore, according to the vehicle component assembly system according to the embodiment of the present disclosure illustrated in FIG. 9, the fastening inspection unit may combine the images captured at four angles, extract the coordinate value of the accurate shape of the coupling portion in respect to the shape of the object that varies depending on viewing angle, and inspect whether the hardware component is not fastened or precisely fastened, thereby more uniformly managing the mounting quality of the vehicle component.

FIG. 10 is a flowchart illustrating a vehicle component assembly method according to the embodiment of the present disclosure. The vehicle component assembly method according to the present disclosure includes: capturing, by the image capturing unit, the image of the mounted vehicle component and the image of the assembly point on the vehicle to which the vehicle component is assembled (S100); loading, by the assembly robot, the mounted vehicle component (S200), moving the loaded vehicle component to the assembly point on the vehicle, and assembling the vehicle component to the assembly point (S300); and analyzing, by the control unit, the image of the vehicle component (S400), controlling the assembly robot to load the mounted vehicle component at the same point, analyzing the image of the assembly point on the vehicle, and controlling the assembly robot to accurately assemble the vehicle component to the assembly point on the vehicle (S500).

In the controlling step S500, the control unit may calculate loading information associated with the loading point of the vehicle component and assembly information associated with the assembly point of the vehicle component by analyzing the image of the vehicle component and the image of the assembly point on the vehicle which are captured by the image capturing unit. The control unit may calculate errors from preset reference loading information and reference assembly information depending on the calculated loading information associated with the loading point of the vehicle component and the calculated assembly information associated with the assembly point of the vehicle component and control the assembly robot depending on the calculated errors.

After the controlling step S500, the fastening inspection unit may control the image capturing unit to allow the image capturing unit to capture the images, at multiple angles, the assembled state of the vehicle in which the vehicle component is assembled. The fastening inspection unit may process the images captured at multiple angles by the image capturing unit, generate the fastening inspection information associated with the result of inspecting the fastening of the hardware component, calculate the error between the fastening inspection information and the preset reference fastening information, and control the operation of the fastening robot depending on the calculated error.

In the assembling step S300, the loading robot may load the mounted vehicle component and move the loaded vehicle component to the assembly point on the vehicle, and the fastening robot may assemble the moved vehicle component to the assembly point by positioning the hardware component, including one or more types of bolts, nuts, or clips, at the assembly point and applying torque to the hardware component.

In the controlling step S500, the control unit may analyze the image of the assembly point on the vehicle, calculate the fastening information associated with the fastening point of the hardware component, calculate an error from a preset reference fastening information depending on the calculated fastening information, and control the operation of the fastening robot depending on the calculated error in the case in which the hardware component is fastened and assembled to the assembly point in the state in which the vehicle component is loaded at the loading point.

In the assembling step S300, the loading robot may receive the sucking positions of the sucking unit, which are different for respective types of vehicles, and operate the servo motor to the sucking position, and the vacuum blower may generate sucking power in the sucking unit positioned at the sucking position.

Meanwhile, the term “unit” in the present embodiment may be software, hardware, or a combination thereof. In addition, the term “unit” in the present embodiment may be included in a computer-readable storage medium. In addition, the term “unit” in the present embodiment may be partially dispersed and distributed in a plurality of hardware or software components or a combination thereof. Further, the term “unit” in the present embodiment may be configured as a hardware component so as to operate as one or more software modules, and the opposite is also possible.

In addition, the method of “controlling the assembly robot depending on the error” in the present embodiment includes basic control such as PD, PI, and PID control, PI-D control as two-degree-of-freedom control in which defect controllers are placed in the feed-forward path and the feedback path, lag compensation control such as PI-PD control, lead-lag compensation control, series compensation) or parallel compensation thereof, and compliance control.

While the specific embodiments of the present disclosure have been illustrated and described above, it will be obvious to those skilled in the art that the present disclosure may be variously modified and changed without departing from the technical spirit of the present disclosure defined in the appended claims.

Therefore, it is apparent to those skilled in the field of the vehicle that the term “unit” or “step” in the embodiment of the present disclosure may implement one new embodiment by being combined with the term “unit” or “step” of different embodiments of the present disclosure. For example, it is apparent to those skilled in the art that in the vehicle component assembly system according to the embodiment of the present disclosure, it is possible to implement a new embodiment in which the loading robot further includes the sucking unit configured to suck the mounted vehicle component, and the vacuum blower configured to generate sucking power in the sucking unit, and the loading robot further includes the servo motor configured to move the sucking unit, and the precise movement device configured to operate the servo motor by receiving the sucking positions of the sucking unit which are different for respective types of vehicles.

What is claimed is:

1. A system for assembling a vehicle component, the system comprising:
an image capturing unit configured to capture an image of a mounted vehicle component and an image of an assembly point on a vehicle to which the vehicle component is assembled;
an assembly robot configured to load the mounted vehicle component, move the loaded vehicle component to the assembly point on the vehicle, and assemble the vehicle component to the assembly point; and
a control unit configured to analyze the image of the vehicle component captured by the image capturing unit, control the assembly robot to allow the assembly robot to load the mounted vehicle component at the same point, analyze the image of the assembly point on the vehicle, and control the assembly robot to allow the assembly robot to assemble the vehicle component accurately to the assembly point of the vehicle.

2. The system of claim 1, wherein the control unit analyzes the image of the vehicle component and the image of the assembly point on the vehicle, which are captured by the image capturing unit, calculates loading information associated with a loading point of the vehicle component and assembly information associated with the assembly point of the vehicle component, calculates errors from preset reference loading information and reference assembly information depending on the calculated loading information associated with the loading point of the vehicle component and the calculated assembly information associated with the assembly point of the vehicle component, and controls the assembly robot depending on the calculated errors.

3. The system of claim 1, wherein the assembly robot comprises:
a loading robot configured to load the mounted vehicle component and move the loaded vehicle component to the assembly point on the vehicle; and
a fastening robot configured to assemble the moved vehicle component to the assembly point by positioning a hardware component, including one or more types of bolts, nuts, or clips, at the assembly point and applying torque to the hardware component.

4. The system of claim 3, wherein the control unit analyzes the image of the vehicle component and the image of the assembly point on the vehicle, which are captured by the image capturing unit, calculates loading information associated with a loading point of the vehicle component and assembly information associated with the assembly point of the vehicle component, calculates errors from a reference loading point and a reference assembly point depending on the calculated loading point and the calculated assembly point of the vehicle component, derives movement routes of the loading robot and the fastening robot depending on the calculated errors, and controls operations of the loading robot and the fastening robot depending on the derived movement routes.

5. The system of claim 3, wherein the control unit analyzes the image of the assembly point on the vehicle, calculates fastening information associated with a fastening point of the hardware component, calculates an error from a preset reference fastening information depending on the calculated fastening information, and controls an operation of the fastening robot depending on the calculated error in a case in which the hardware component is fastened and assembled to the assembly point in a state in which the vehicle component is loaded to the loading point.

6. The system of claim 3, wherein the loading robot further comprises:
a sucking unit configured to suck the mounted vehicle component; and
a vacuum blower configured to generate sucking power in the sucking unit.

7. The system of claim 6, wherein the loading robot further comprises:
a servo motor configured to move the sucking unit; and
a precise movement device configured to operate the servo motor by receiving sucking positions of the sucking unit which are different for respective types of vehicles.

8. The system of claim 1, wherein the control unit further comprises a fastening inspection unit configured to inspect whether the assembly robot accurately assembles the vehicle component to the assembly point on the vehicle by fastening one or more types of hardware components among bolts, nuts, or clips to the vehicle component, and
wherein the fastening inspection unit controls the image capturing unit to capture, at multiple angles, images of an assembled state of the vehicle in which the vehicle component is assembled, processes the images captured at multiple angles by the image capturing unit, generates fastening inspection information associated with a result of inspecting the fastening of the hardware component, calculates an error between the fastening inspection information and preset reference fastening information, and controls an operation of the assembly robot depending on the calculated error.

9. A method of assembling a vehicle component, the method comprising:
capturing, by an image capturing unit, an image of a mounted vehicle component and an image of an assembly point on a vehicle to which the vehicle component is assembled;
loading, by an assembly robot, the mounted vehicle component, moving the loaded vehicle component to the assembly point on the vehicle, and assembling the vehicle component to the assembly point; and
analyzing, by a control unit, the image of the vehicle component, controlling the assembly robot to load the mounted vehicle component at the same point, analyzing the image of the assembly point on the vehicle, and controlling the assembly robot to assemble the vehicle component accurately to the assembly point on the vehicle.

10. The method of claim 9, wherein in the controlling step, the control unit analyzes the image of the vehicle component and the image of the assembly point on the vehicle, which are captured by the image capturing unit, calculates loading information associated with a loading point of the vehicle component and assembly information associated with the assembly point of the vehicle component, calculates errors from preset reference loading information and reference assembly information depending on the calculated loading information associated with the loading point of the vehicle component and the calculated assembly information associated with the assembly point of the vehicle component, and controls the assembly robot depending on the calculated errors.

11. The method of claim 9, wherein after the controlling step, a fastening inspection unit controls the image capturing unit to capture, at multiple angles, images of an assembled state of the vehicle in which the vehicle component is assembled, processes the images captured at multiple angles by the image capturing unit, generates fastening inspection information associated with a result of inspecting the fastening of a hardware component, calculates an error between the fastening inspection information and preset reference fastening information, and controls an operation of a fastening robot depending on the calculated error.

12. The method of claim 9, wherein in the assembling step, a loading robot loads the mounted vehicle component and moves the loaded vehicle component to the assembly point on the vehicle, and a fastening robot assembles the moved vehicle component to the assembly point by positioning a hardware component, including one or more types of bolts, nuts, or clips, to the assembly point and applying torque to the hardware component.

13. The method of claim 12, wherein in the controlling step, the control unit analyzes the image of the assembly point on the vehicle, calculates fastening information associated with a fastening point of the hardware component, calculates an error from a preset reference fastening information depending on the calculated fastening information, and controls an operation of the fastening robot depending on the calculated error in a case in which the hardware component is fastened and assembled to the assembly point in a state in which the vehicle component is loaded to a loading point.

14. The method of claim 9, wherein in the controlling step, the control unit analyzes the image of the vehicle component and the image of the assembly point on the vehicle, which are captured by the image capturing unit, calculates loading information associated with a loading point of the vehicle component and assembly information associated with the assembly point of the vehicle component, calculates errors from a reference loading point and a reference assembly point depending on the calculated loading point and the calculated assembly point of the vehicle component, derives movement routes of a loading robot and a fastening robot depending on the calculated errors, and controls operations of the loading robot and the fastening robot depending on the derived movement routes.

15. The method of claim 12, wherein in the assembling step, the loading robot receives sucking positions of a sucking unit, which are different for respective types of vehicles, and operates a servo motor to a sucking position, and a vacuum blower generates sucking power in the sucking unit positioned at the sucking position.
